(19) United States
(12) Patent Application Publication
(10) Pub. No.: US 2013/0166504 A1
(43) Pub. Date: Jun. 27, 2013

(54) SYSTEMS AND METHODS FOR VIRTUAL MACHINE MIGRATION

(71) Applicant: RiverMeadow Software, Inc., Westford, MA (US)

(72) Inventors: Anil Varkhedi, San Jose, CA (US); Sanjay Mazumder, Westford, MA (US); Anil Vayaal, Tyngsborough, MA (US); Scott Metzger, San Luis Obispo, CA (US)

(73) Assignee: RiverMeadow Software, Inc., Westford, MA (US)

(21) Appl. No.: 13/724,792

(22) Filed: Dec. 21, 2012

Related U.S. Application Data
(60) Provisional application No. 61/580,498, filed on Dec. 27, 2011.

(51) Int. Cl. G06F 17/30

(52) U.S. Cl. CPC G06F 17/30581
USPC 707/610

(57) ABSTRACT

Migration or cloning of a source machine from a source platform to a destination platform includes collecting an image of the source machine in a storage device of a migration platform, converting the image of the source machine for deployment in a virtualization environment, deploying the converted image to a selected virtualization environment in the destination platform, and synchronizing data of the deployed converted image to current data on the source machine, if the data on the source machine has changed since the image of the source machine was collected.

### RELATED APPLICATIONS

This application claims priority to U.S. Provisional Patent Application No. 61/580,498 entitled “Systems and Methods for Virtual Machine Migration,” filed Dec. 27, 2011, which is incorporated herein by reference in its entirety.

### BACKGROUND

The term “cloud computing” generally describes a pool of abstracted software, network, computing, and storage services. Cloud resources are hosted over a network, and do not require end-user knowledge of the physical location or configuration of the physical systems. Clouds may be shared (i.e. public) or may be private.

Cloud infrastructure runs on top of a virtualization layer. The virtualization layer is generally referred to as the hypervisor. Hypervisors can run on a specific operating system platform or can run without an operating system. Guest virtual machines run on the hypervisor. A hypervisor can support several guest virtual machines.

From the perspective of a user interface, a guest virtual machine appears like a physical machine. Each guest virtual machine runs an operating system, has network interfaces and has dedicated storage. The underlying hypervisor provides computing, network and storage resources to the guest machines.

It is desirable to have the capability to replace a local physical machine with a guest virtual machine on a hypervisor or cloud platform, to move a guest virtual machine from one platform to another, or to clone a physical or virtual machine. Present migration techniques may require the installation of software on the physical or virtual machine prior to migration, such as the installation of a software agent or an imaging utility. Present migration techniques may require control of the physical or virtual machine during the migration, leading to downtime of the machine. Present migration techniques also may require persistent continuous network connectivity between the source machine and the target machine throughout the migration, making the migration intrusive, network dependent and unreliable. Further, working storage has to be provided on the source for conversion using present migration techniques, and stale data resulting from migration must be addressed manually.

Moreover, for at least the above reasons, the processes used by present migration techniques are not scalable and thus do not address datacenter migration scenarios.

An improved migration technique is therefore desirable.

### SUMMARY

Migration or cloning of a source machine from a source platform to a destination platform includes collecting an image of the source machine in a storage device of a migration platform, converting the image of the source machine for deployment in a virtualization environment, deploying the converted image to a selected virtualization environment in the destination platform, and synchronizing data of the deployed converted image to current data on the source machine, if the data on the source machine has changed since the image of the source machine was collected.

### BRIEF DESCRIPTION OF THE DRAWINGS

FIG. 1 illustrates an example of a computing environment.

FIG. 2 illustrates an example of a computing device.

FIG. 3 illustrates an example of a technique for migrating a source machine to a destination platform.

FIG. 4 illustrates an example of a system for migrating a source machine to a destination platform.

FIG. 5 illustrates an example of configuring a collection device.

FIG. 6 illustrates an example of managing source machines.

FIG. 7 illustrates an example of adding a source machine for management.

FIG. 8 illustrates an example of scheduling a collection.

FIG. 9 illustrates an example of configuring source machine information.

FIG. 10 illustrates an example of collection metrics.

FIG. 11 illustrates an example of initiation of collection.

FIG. 12 illustrates another example of collection metrics

FIG. 13 illustrates an example of configuring a conversion device.

FIG. 14 illustrates an example of initiating conversion.

FIG. 15 illustrates an example of initiating deployment.

FIG. 16 illustrates an example of initiating synchronization.

### DETAILED DESCRIPTION

The migration of physical and virtual machines to or between virtualization platforms is desirable since virtualization offers elasticity of resources for computing as well as dynamic and rapid allocation of resources. Resources may be provisioned or apportioned to support more load or less load as needs arise, helping to optimize the use of compute, network and storage resources, and allowing better utilization of physical computing resources.

Cloud computing further allows for self-provisioning and auto-provisioning of resources. For example, a web application server may be overloaded during the holiday season, in which case more processor and memory resources can be assigned to a virtual machine. Once the holiday season is over, the processor and memory resources can be scaled back again.

Cloud providers often provide a set of templates or prepared server images with the cloud software stack. A manual process for migrating an existing (source) machine to a cloud is to instantiate a virtual machine from the templates, and then manually move the data from the source machine to the virtual machine. This manual process is time consuming and error prone. Additionally, because the source machine may have already been running for a long time with several software packages and lots of configuration data, and may have had multiple users with corresponding user data, it is difficult to create an exact replica of the source machine. The difficulties and errors compound in a multi-machine environment.

Described below is an automated migration framework that replaces the time consuming and error-prone manual processes. The automated migration framework allows for a non-intrusive, remote collection of images of physical and virtual machines running different operating systems and applications, with different application data and configurations, and migrating the images to a virtualization environment.

The automated migration framework collects an image of a source machine or machines, converts the image to run in a virtualization environment, adds applicable device drivers and operating systems, adjusts the disk geometry in the hypervisor metadata, and moves or copies the image onto the virtualization platform. The automated migration framework can manipulate the images to adhere to any cloud platform image format.

The collecting of a source image and the converting of the image may be performed separately, and at different times. To avoid operating in the target virtualization environment with stale data due to performing the conversion after a delay, the automated migration framework also includes synchronization of source and target data. The synchronization may be performed as a live or nearly live synchronization.

Thus, the automated migration framework provides scalability and accuracy, and allows for large-scale migrations.

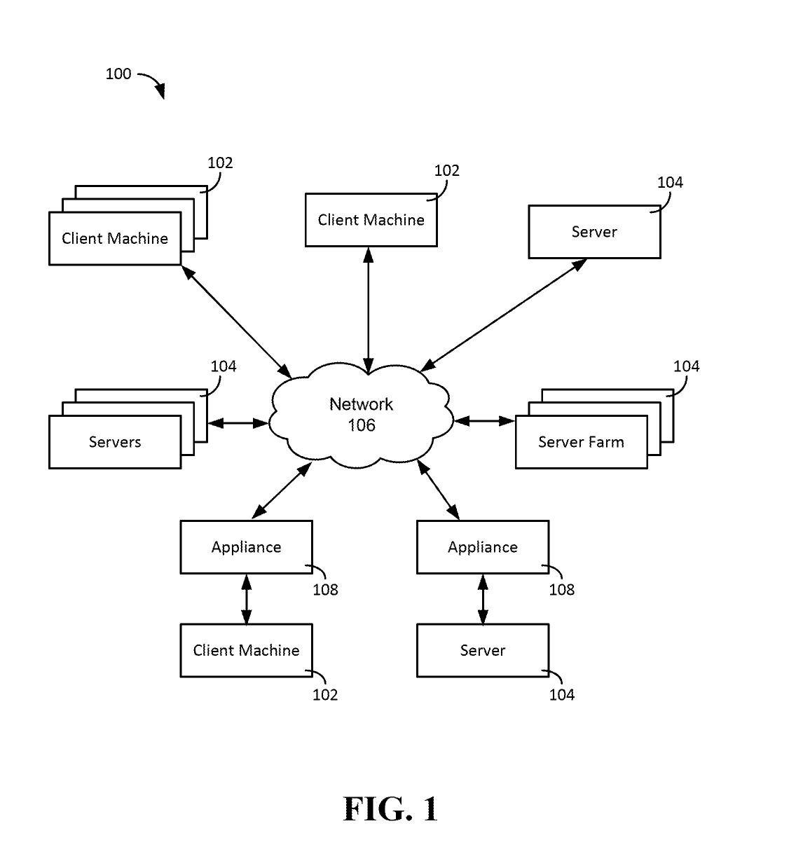

FIG. 1 illustrates one embodiment of a computing environment 100 that includes one or more client machines 102 in communication with one or more servers 104 over a network 106. One or more appliances 108 may be included in the computing environment 100.

As illustrated in FIG. 1, a client machine 102 may represent multiple client machines 102, and a server 104 may represent multiple servers 104.

A client machine 102 can execute, operate or otherwise provide an application. The term application includes, but is not limited to, a virtual machine, a hypervisor, a web browser, a web-based client, a client-server application, a thin-client computing client, an ActiveX control, a Java applet, software related to voice over internet protocol (VoIP) communications, an application for streaming video and/or audio, an application for facilitating real-time-data communications, an HTTP client, an FTP client, an Oscar client, and a Telnet client.

In some embodiments, a client machine 102 is a virtual machine. A virtual machine may be managed by a hypervisor. A client machine 102 that is a virtual machine may be managed by a hypervisor executing on a server 104 or a hypervisor executing on a client machine 102.

Some embodiments include a client machine 102 that displays application output generated by an application remotely executing on a server 104 or other remotely located machine. The client machine 102 may display the application output in an application window, a browser, or other output window. In one embodiment, the application is a desktop, while in other embodiments the application is an application that generates a desktop.

A server 104 may be, for example, a file server, an application server or a master application server, a web server, a proxy server, an appliance, a network appliance, a gateway, an application gateway, a gateway server, a virtualization server, a deployment server, an SSL VPN server, a firewall, or a web server. Other examples of a server 104 include a server executing an active directory, and a server executing an application acceleration program that provides firewall functionality, application functionality, or load balancing functionality. In some embodiments, a server 104 may be a RADIUS server that includes a remote authentication dial-in user service.

A server 104, in some embodiments, executes a remote presentation client or other client or program that uses a thin-client or remote-display protocol to capture display output generated by an application executing on a server 104 and transmits the application display output to a remote client machine 102. The thin-client or remote-display protocol can use proprietary protocols, or industry protocols such as the Independent Computing Architecture (1CA) protocol from Citrix Systems, Inc. of Ft. Lauderdale, Fla. or the Remote Desktop Protocol (RDP) from the Microsoft Corporation of Redmond, Wash.

A computing environment 100 can include servers 104 logically grouped together into a server farm 104. A server farm 104 can include servers 104 that are geographically dispersed, or servers 104 that are located proximate each other. Geographically dispersed servers 104 within a server farm 104 can, in some embodiments, communicate using a wide area network (WAN), metropolitan area network (MAN), or local area network (LAN). Geographic dispersion is dispersion over different geographic regions, such as over different continents, different regions of a continent, different countries, different states, different cities, different campuses, different rooms, or a combination of geographical locations. A server farm 104 can include multiple server farms 104.

A server farm 104 can include a first group of servers 104 that execute a first type of operating system platform and one or more other group of servers 104 that execute one or more other types of operating system platform. In some embodiments, a server farm 104 includes servers 104 that each execute a substantially similar type of operating system platform. Examples of operating system platform types include WINDOWS NT and Server 20xx, manufactured by Microsoft Corp. of Redmond, Wash., UNIX, LINUX, and OS-X manufactured by Apple Corp. of Cupertino, Calif.

Some embodiments include a first server 104 that receives a request from a client machine 102, forwards the request to a second server 104, and responds to the request with a response from the second server 104. The first server 104 can acquire an enumeration of applications available to the client machine 102 as well as address information associated with an application server 104 hosting an application identified within the enumeration of applications. The first server 104 can then present a response to the request of the client machine 102 using, for example, a web interface, and communicate directly with the client machine 102 to provide the client machine 102 with access to an identified application.

A server 104 may execute one or more applications. For example, a server 104 may execute a thin-client application using a thin-client protocol to transmit application display data to a client machine 102, execute a remote display presentation application, execute a portion of the CITRIX ACCESS SUITE by Citrix Systems, Inc. such as XenApp or XenDesktop, execute MICROSOFT WINDOWS Terminal Services manufactured by the Microsoft Corporation, or execute an ICA client.

A server 104 may be an application server such as a server providing email services, a web or Internet server, a desktop sharing server, or a collaboration server, for example. A server 104 may execute hosted server applications such as GOTOMEETING provided by Citrix Online Division, Inc., WEBEX provided by WebEx, Inc. of Santa Clara, Calif., or Microsoft Office LIVE MEETING provided by Microsoft Corporation.

A client machine 102 may seek access to resources provided by a server 104. A server 104 may provide client machines 102 with access to hosted resources.

A server 104 may function as a master node that identifies address information associated with a server 104 hosting a requested application, and provides the address information to one or more clients 102 or servers 104. In some implementations, a master node is a server farm 104, a client machine 102, a cluster of client machines 102, or an appliance 108.

A network 106 may be, or may include, a LAN, MAN, or WAN. A network 106 may be, or may include, a point-to-point network, a broadcast network, a telecommunications network, a data communication network, a computer network, an Asynchronous Transfer Mode (ATM) network, a Synchronous Optical Network (SONET), or a Synchronous Digital Hierarchy (SDH) network, for example. A network 106 may be, or may include, a wireless network, a wired network, or a wireless link where the wireless link may be, for example, an infrared channel or satellite band.

The topology of network 106 can differ within different embodiments, and possible network topologies include among others a bus network topology, a star network topology, a ring network topology, a repeater-based network topology, a tiered-star network topology, or combinations of two or more such topologies. Additional embodiments may include mobile telephone networks that use a protocol for communication among mobile devices, such as AMPS, TDMA, CDMA, GSM, GPRS, UMTS or the like.

A network 106 can comprise one or more sub-networks. For example, a network 106 may be a primary public network 106 with a public sub-network 106, a primary public network 106 with a private sub-network 106, a primary private network 106 with a public sub-network 106, or a primary private network 106 with a private sub-network 106.

An appliance 108 can manage client/server connections, and in some cases can load-balance client connections amongst a plurality of servers 104. An appliance 108 may be, for example, an appliance from the Citrix Application Networking Group, Silver Peak Systems, Inc, Riverbed Technology, Inc., F5 Networks, Inc., or Juniper Networks, Inc.

In some embodiments, one or more of client machine 102, server 104, and appliance 108 is, or includes, a computing device.

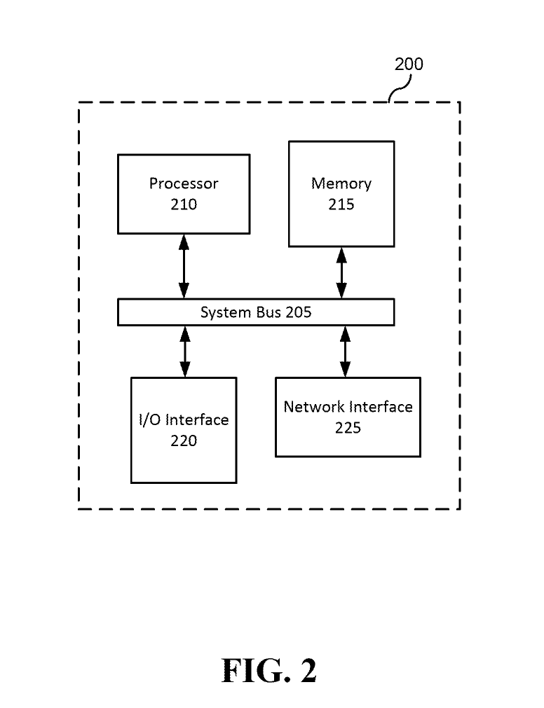

FIG. 2 illustrates one embodiment of a computing device 200 that includes a system bus 205 for communication between a processor 210, memory 215, an input/output (I/O) interface 220, and a network interface 225. Other embodiments of a computing device include additional or fewer components, and may include multiple instances of one or more components.

System bus 205 represents one or more physical or virtual buses within computing device 200. In some embodiments, system bus 205 may include multiple buses with bridges between, and the multiple buses may use the same or different protocols. Some examples of bus protocols include VESA VL, ISA, EISA, MicroChannel Architecture (MCA), PCI, PCI-X, PCIExpress, and NuBus.

Processor 210 may represent one or more processors 210, and a processor 210 may include one or more processing cores. A processor 210 generally executes instructions to perform computing tasks. Execution may be serial or parallel. In some embodiments, processor 210 may include a graphics processing unit or processor, or a digital signal processing unit or processor.

Memory 215 may represent one or more physical memory devices, including volatile and non-volatile memory devices or a combination thereof. Some examples of memory include hard drives, memory cards, memory sticks, and integrated circuit memory. Memory 215 contains processor instructions and data. For example, memory 215 may contain an operating system, application software, configuration data, and user data.

The I/O interface 220 may be connected to devices such as a key board, a pointing device, a display, or other memory, for example.

One embodiment of the computing machine 200 includes a processor 210 that is a central processing unit in communication with cache memory via a secondary bus (also known as a backside bus). Another embodiment of the computing machine 200 includes a processor 210 that is a central processing unit in communication with cache memory via the system bus 205. The local system bus 205 can, in some embodiments, also be used by processor 210 to communicate with more than one type of I/O device through I/O interface 220.

I/O interface 220 may include direct connections and local interconnect buses.

Network interface 225 provides connection through a variety of connections including, but not limited to, standard telephone lines, LAN or WAN links (e.g., 802.11, T1, T2, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FADDY), RS232, RS485, IEEE 802.11, IEEE 802.11a, IEEE 802.11b, IEEE 802.11g, CDMA, GSM, WiMax and direct asynchronous connections).

One version of computing device 200 includes a network interface 225 able to communicate with additional computing devices 200 via a gateway or tunneling protocol such as Secure Socket Layer (SSL) or Transport Layer Security (TLS), or the Citrix Gateway Protocol manufactured by Citrix Systems, Inc. The network interface 225 may be a built-in network adapter, a network interface card, a PCMCIA network card, a card bus network adapter, a wireless network adapter, a USB network adapter, a modem, or other device.

The computing device 200 can be embodied as a computing workstation, a desktop computer, a laptop or notebook computer, a server, a handheld computer, a mobile telephone, a portable telecommunication device, a media playing device, a gaming system, a mobile computing device, a netbook, a device of the IPOD family of devices manufactured by Apple Computer, any one of the PLAYSTATION family of devices manufactured by the Sony Corporation, any one of the Nintendo family of devices manufactured by Nintendo Co, any one of the XBOX family of devices manufactured by the Microsoft Corporation, or other type or form of computing, telecommunications or media device.

A physical computing device 200 may include one or more processors 210 that execute instructions to emulate an environment or environments, thereby creating a virtual machine or machines.

A virtualization environment may include a hypervisor that executes within an operating system executing on a computing device 200. For example, a hypervisor may be of Type 1 or Type 2. A Type 2 hypervisor, in some embodiments, executes within an operating system environment and virtual machines execute at a level above the hypervisor. In many embodiments, a Type 2 hypervisor executes within the context of an operating system such that the Type 2 hypervisor interacts with the operating system. A virtualization environment may encompass multiple computing devices 200. For example, a virtualization device may be physically embodied in a server farm 104.

A hypervisor may manage any number of virtual machines. A hypervisor is sometimes referred to as a virtual machine monitor, or platform virtualization software. A guest hypervisor may execute within the context of a host operating system executing on a computing device 200.

In some embodiments, a computing device 200 can execute multiple hypervisors, which may be the same type of hypervisor, or may be different hypervisor types.

A hypervisor may provide virtual resources to operating systems or other programs executing on virtual machines to simulate direct access to system resources. System resources include physical disks, processors, memory, and other components included in the computing device 200 or controlled by the computing device 200.

The hypervisor may be used to emulate virtual hardware, partition physical hardware, virtualize physical hardware, or execute virtual machines that provide access to computing environments. In some embodiments, the hypervisor controls processor scheduling and memory partitioning for a virtual machine executing on the computing device 200. In some embodiments, a computing device 200 executes a hypervisor that creates a virtual machine platform on which guest operating systems may execute. In these embodiments, the computing device 200 can be referred to as a host.

A virtual machine may include virtual memory and a virtual processor. Virtual memory may include virtual disks. A virtual disk is a virtualized view of one or more physical disks of the computing device 200, or a portion of one or more physical disks of the computing device 200. The virtualized view of physical disks can be generated, provided and managed by a hypervisor. In some embodiments, a hypervisor provides each virtual machine with a unique view of physical disks.

A virtual processor is a virtualized view of one or more physical processors of the computing device 200. In some embodiments, the virtualized view of the physical processors can be generated, provided and managed by the hypervisor. In some embodiments, the virtual processor has substantially all of the same characteristics of at least one physical processor. In other embodiments, the virtual processor provides a modified view of the physical processor such that at least some of the characteristics of the virtual processor are different than the characteristics of the corresponding physical processor.

A hypervisor may execute a control program within a virtual machine, and may create and start the virtual machine. In embodiments where the hypervisor executes the control program within a virtual machine, that virtual machine can be referred to as the control virtual machine. In some embodiments, a control program on a first computing device 200 may exchange data with a control program on a second computing device 200. The first computing device 200 and second computing device 200 may be remote from each other. The computing devices 200 may exchange data regarding physical resources available in a pool of resources, and may manage a pool of resources. The hypervisors can further virtualize these resources and make them available to virtual machines executing on the computing devices 200. A single hypervisor can manage and control virtual machines executing on multiple computing devices 200.

In some embodiments, a control program interacts with one or more guest operating systems. Through the hypervisor, the guest operating system(s) can request access to hardware components. Communication between the hypervisor and guest operating systems may be, for example, through shared memory pages.

In some embodiments, a control program includes a network back-end driver for communicating directly with networking hardware provided by the computing device 200. In one of these embodiments, the network back-end driver processes at least one virtual machine request from at least one guest operating system. In other embodiments, the control program includes a block back-end driver for communicating with a storage element on the computing device 200. A block back-end driver may read and write data from a storage element based upon at least one request received from a guest operating system.

A control program may include a tools stack, such as for interacting with a hypervisor, communicating with other control programs (for example, on other computing devices 200), or managing virtual machines on the computing device 200. A tools stack may include customized applications for providing improved management functionality to an administrator of a virtual machine farm. In some embodiments, at least one of the tools stack and the control program include a management API that provides an interface for remotely configuring and controlling virtual machines running on a computing device 200.

A hypervisor may execute a guest operating system within a virtual machine created by the hypervisor. A guest operating system may provide a user of the computing device 200 with access to resources within a computing environment. Resources include programs, applications, documents, files, a desktop environment, a computing environment, and the like. A resource may be delivered to a computing device 200 via a plurality of access methods including, but not limited to, conventional installation directly on the computing device 200, delivery to the computing device 200 via a method for application streaming, delivery to the computing device 200 of output data generated by an execution of the resource on a second computing device 200 and communicated to the computing device 200 via a presentation layer protocol, delivery to the computing device 200 of output data generated by an execution of the resource via a virtual machine executing on a second computing device 200, or execution from a removable storage device connected to the computing device 200, such as a USB device, or via a virtual machine executing on the computing device 200 and generating output data.

In one embodiment, the guest operating system, in conjunction with the virtual machine on which it executes, forms a fully-virtualized virtual machine that is not aware that it is a virtual machine. Such a machine may be referred to as a “Domain U HVM (Hardware Virtual Machine) virtual machine”. In another embodiment, a fully-virtualized machine includes software emulating a Basic Input/Output System (BIOS) in order to execute an operating system within the fully-virtualized machine. In still another embodiment, a fully-virtualized machine may include a driver that provides functionality by communicating with the hypervisor. In such an embodiment, the driver is typically aware that it executes within a virtualized environment. In another embodiment, a guest operating system, in conjunction with the virtual machine on which it executes, forms a para-virtualized virtual machine, which is aware that it is a virtual machine; such a machine may be referred to as a “Domain U PV virtual machine”. In another embodiment, a para-virtualized machine includes additional drivers that a fully-virtualized machine does not include. In still another embodiment, the para-virtualized machine includes a network back-end driver and a block back-end driver included in a control program.

A Type 2 hypervisor can access system resources through a host operating system, as described. A Type 1 hypervisor can directly access all system resources. A Type 1 hypervisor can execute directly on one or more physical processors of the computing device 200.

In a virtualization environment that employs a Type 1 hypervisor configuration, the host operating system can be executed by one or more virtual machines. Thus, a user of the computing device 200 can designate one or more virtual machines as the user's personal machine. This virtual machine can imitate the host operating system by allowing a user to interact with the computing device 200 in substantially the same manner that the user would interact with the computing device 200 via a host operating system.

Virtual machines can be unsecure or secure, sometimes referred to as privileged and unprivileged. In some embodiments, a virtual machine's security can be determined based on a comparison of the virtual machine to other virtual machines executing within the same virtualization environment. For example, were a first virtual machine to have access to a pool of resources, and a second virtual machine not to have access to the same pool of resources, the second virtual machine could be considered an unsecure virtual machine while the first virtual machine could be considered a secure virtual machine. In some embodiments, a virtual machine's ability to access one or more system resources can be configured using a configuration interface generated by either the control program or the hypervisor. In other embodiments, the level of access afforded to a virtual machine can be the result of a review of any of the following sets of criteria: the user accessing the virtual machine; one or more applications executing on the virtual machine; the virtual machine identifier; a risk level assigned to the virtual machine based on one or more factors; or other criteria.

Having described a computing environment 100 and a computing device 200, a framework for automated migration is next described.

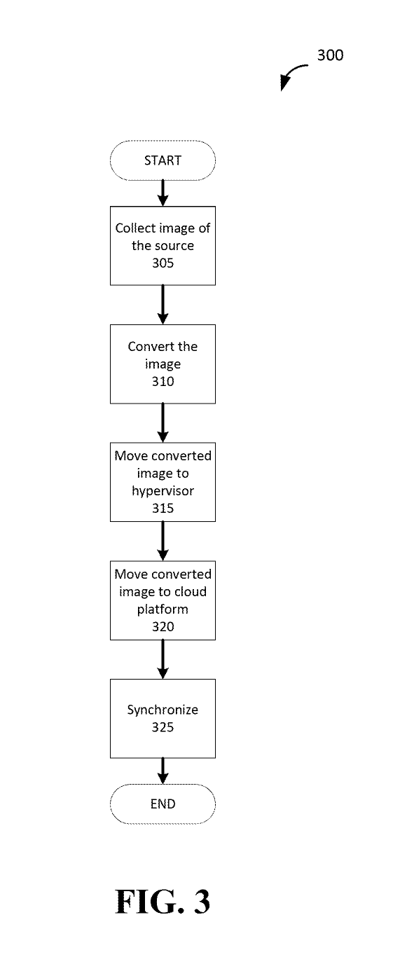

FIG. 3 illustrates an example process 300 for migrating from one platform to another, including data collection, conversion, movement of the converted data to a hypervisor, movement of the data to a cloud platform, and data synchronization.

Process 300 starts at block 305 by collecting an image of the source machine to be migrated. A source machine may be, for example, a client machine 102 or a server 104. Image collection may be performed by a virtual appliance preconfigured to run the process of collection of images from multiple source machine substantially simultaneously, sequentially, or at separate times. The software to run the process may execute on a virtual appliance running on a hypervisor.

Collecting an image of a source machine involves taking a “snapshot” of the contents of the source machine, so that an image of the source machine is preserved. The image includes the operating system, configuration and application data. The imaging process is provided by the source machine operating system. The source machine continues to operate during image collection.

In some embodiments, working storage for the migration is provided by using appliance storage and thus no additional storage is necessary at the source machine during collection. The appliance storage may be direct access storage or network mounted storage.

Using a web console on the collector appliance (using, for example, a client machine 102 as described above), a user may inititate a remote connection to the source machine, mount the storage attached to the appliance, and begin executing scripts such as shell scripts or Visual Basic (VB) scripts to collect the image. Attributes of the source machine may also be collected during this process, or may be collected in a separate process. Attributes may also be collected after a target copy is deployed. Attributes may be warehoused and aggregated to provide further insights into workload deployments.

In some embodiments, collection is performed by a web application, web service, or Software as a Service (SaaS). Collection may be performed on multiple machines concurrently, such as collection from a server cluster, and collection from the individual servers in a server cluster may be substantially simultaneous.

In many embodiments, the collector is a physical or virtual appliance, which performs non-intrusive remote image collection without requiring reboot of the source machine or continuous network connectivity between the source machine and the hypervisor. The collector is highly scalable and supports parallel collections.

In some embodiments, if large amounts of data are to be collected or when the connectivity is a challenge, for example, the collector may be packaged as a physical box. In this case, storage may be provided locally or over a network.

In other embodiments the collector may be packaged as a virtual machine, in which case storage is attached to the virtual machine.

Process 300 continues at block 310 to convert the collected image for eventual movement to a target platform. The conversion may be performed concurrently or separately from the collection.

Conversion of an image includes creating a raw root or OS disk image of the target size, along with creating a raw image setup with the layout as needed by the operating system, including making the changes to make the disk bootable with the right master boot records and partition creation. The root disk is then mounted and populated with the image obtained during collection (at block 305). Appropriate drivers and operating system kernels are then installed for all hypervisor platforms. At this point the image is hypervisor agnostic and may be deployed and booted on any hypervisor platform.

Conversion of an image may include adding or deleting software.

Process 300 continues at block 315 to move the image created during the conversion process to the hypervisor. The move may be made either through application interfaces supported by the hypervisor, or the image may be moved to the hypervisor using existing file transfer methods, such as SMB, SCP, HTTPS or SFTP.

The target of a migration can be a hypervisor or a cloud platform. If the target is a hypervisor, the converted image may be moved to a test hypervisor or directly to the target hypervisor for testing. In the latter case, the target hypervisor is also the test hypervisor. In some embodiments, a cloud platform is the target environment. Cloud platforms often do not provide a test environment for images. Thus, if the target is a cloud platform, the converted image may be moved to a test hypervisor before moving it to the cloud platform to allow for environment testing.

The test hypervisor may need to be configured to adapt to the converted image. For example, the converted image may require additional interfaces for network or storage access. Once the converted image is loaded and operating on the test hypervisor, it appears as a virtual machine. The virtual machine is tested for proper functionality on the test hypervisor, and may be modified if necessary for the target environment. After testing, the image is a final image ready to be moved to the target environment. In some embodiments, the test hypervisor is the target environment, and no further movement is required.

Process 300 continues at block 320 to move the final image to the target environment if applicable. The specifics of the move and the operations on the final image depend on the infrastructure of the target platform. Generally, differences in network configuration between a hypervisor and a cloud infrastructure must be considered, software required to run the virtual machine in the target environment is installed, modification of the image for target format is performed if applicable, and modification to run multiple instances of the final image on the target is made if applicable. The final image may be resized. A template image may be created for the target environment.

A collected image can be stored and later converted and deployed, while the source machine continues to run. A delay in conversion or deployment may result in stale data, thereby requiring synchronization at the end of the migration.

Process 300 continues at block 325 to synchronize data between the source and the target. Before production cutover to the target environment, the final image is updated. File-based synchronization may be used to update the image, and synchronization may use checksums and timestamps to determine whether the image is stale. Only data files are synchronized, leaving operating system files intact.

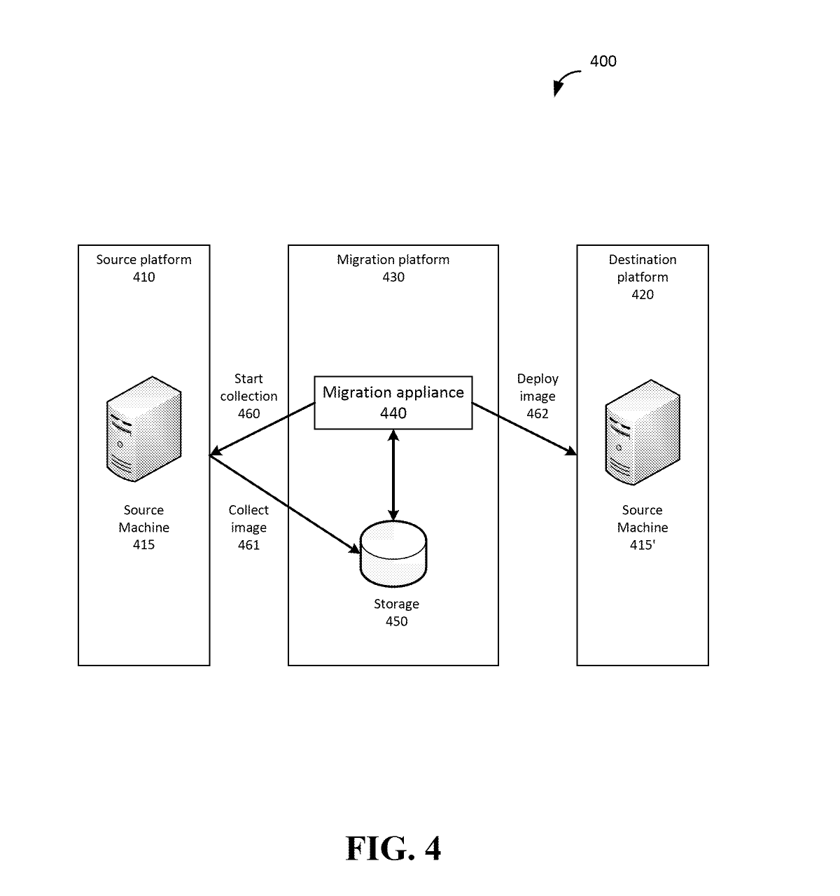

Process 300 may be implemented in a system, such as the example of a system 400 as illustrated in FIG. 4.

FIG. 4 includes a source platform 410 with a source machine 415 to be migrated, and a destination platform 420 which, at completion of migration, contains source machine 415′, a virtualized version of the source machine 415. System 400 also includes a migration platform 430 for migrating the source machine 415 from the source platform 410 to the destination platform 420. Migration platform 430 includes migration appliance 440 and storage 450.

Source platform 410, destination platform 420, and migration platform 430 each include one or more computing devices 200, which may be, for example, client machines 102, servers 104 or a server farm 104. Source platform 410, destination platform 420, and migration platform 430 may include one or more hypervisors, and may be, or may be part of, a cloud environment. Source machine 415 may be a physical device or a virtual device, and may be implemented on one or more computing devices 200.

Migration appliance 440 is an application for performing a non-intrusive migration of source machine 415 to destination platform 420. Migration appliance 440 is in communication with storage 450, for storage of images of source machine 415. Migration appliance 440 may be embodied as a computing device 200, and alternatively may be a virtual device.

Arrows 460, 461, and 462 illustrate information travel direction for specific events occurring during the migration. Arrow 460 indicates that migration appliance 440 initiates collection of an image of source machine 415. Initiation may include, for example, sending a command to source platform 410 or source machine 415 to start an imaging function. Arrow 461 indicates that image data is collected in storage 450. Collection of image data in storage 450 may be controlled by migration appliance 440, source platform 410, or source machine 415. The image is collected and then converted as, for example, is described with respect to FIG. 3 blocks 305 and 310. Arrow 462 indicates that, once the image is converted, it is deployed onto destination platform 420.

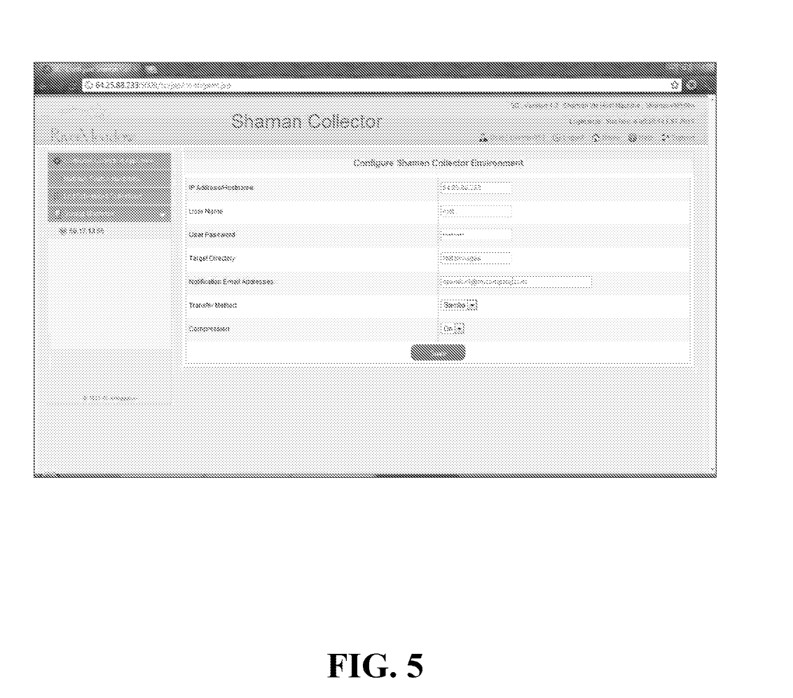

Thus is described an automated migration technique. One example of an automated migration toolset is the Shaman toolset illustrated in FIGS. 5-16. The Shaman toolset is included by way of illustration only, and is not limiting. An automated migration toolset may be, or may be included in, a migration appliance such as migration appliance 440.

FIG. 5 illustrates a web-portal based collector. Specifically, a configuration page of the Shaman Collector is shown. Table 1 describes inputs for the configuration page.

TABLE 1

| Input | Description |
|---|---|
| IP Address/ | IP Address of the Appliance. This is required for the source |
| Hostname | servers to be able to connect to it. For example, |
| | “64.25.88.233”. |
| User Name | User Name of Appliance with root user privileges. For |
| | example, “root”. |
| User | Password for the above User Name. |
| Password | |
| Target | The directory where the collected images are to be stored |
| Directory | and accessed by the Appliance. It is generally |
| | network mapped. For example, “/data/images”. |
| Notification | Destination for notifications during a migration process. |
| Email | For example, operator1@mycompany.com. |
| Addresses | |
| Transfer | The method of transfer of collected images and files. The |
| Method | selectable options in this example collector are samba |
| | and sftp. |
| Compression | If the collected files need to be compressed before transfer, |
| | select On, otherwise Off. Compression increases CPU |
| | utilization of the source server, but the transfer time can |
| | be shorter. |

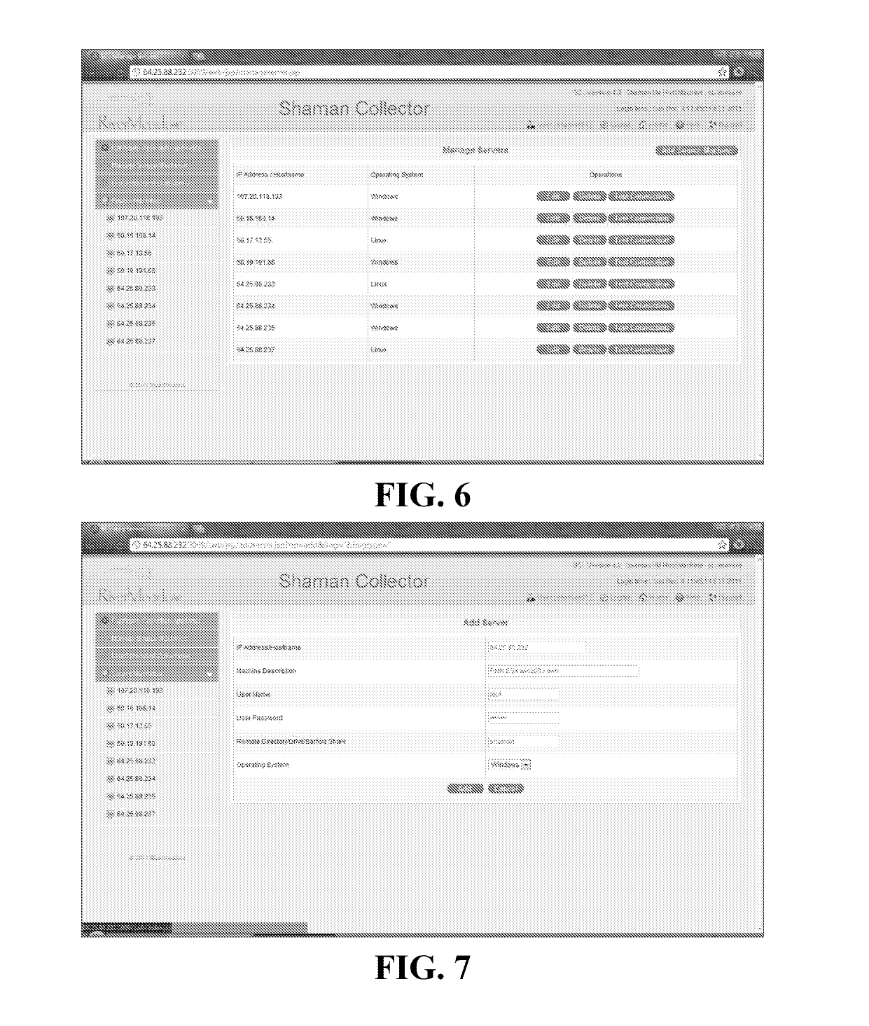

FIG. 6 illustrates a listing of source machines. For each source machine, three columns are displayed: IP Address/Hostname, Operating Systems and Operations.

Selection of the “Delete” button in the Operations column for a source machine will cause a prompt to display to verify if the source machine may be deleted, before deleting that source machine from the list.

Selection of the “Test Connection” button in the Operations column for a source machine will test for present connectivity to that source machine. A progress indicator shows the status of the connection test. Once the test is completed, the progress indicator changes to a message indicating successful completion of the connection test. If the collector was unable to establish a connection, a “Connection Failed” message is presented.

FIG. 7 illustrates a display provided in response to a selection of the button with the label “Add Source Machine” from the page listing the source machines (FIG. 6). Table 2 describes inputs for this display.

TABLE 2

| Input | Description |
|---|---|
| IP Address/ | IP Address of the Source Server. |
| Hostname | |
| Machine | Optional field for identification of the machine. |
| Description | |
| User Name | User Name of Appliance with root (Linux) or Administrator |
| | (Windows) user privileges. For example, “root”. |
| User | Password for the above root or Administrator user. |
| Password | |
| Remote | The directory where the collected images are temporarily |
| Directory/ | stored before transfer to the Appliance. This directory |
| Drive/Samba | is created on the source server and is cleaned up |
| Share | after the collection is completed and transferred. |
| | For example, “tempdir”. |
| Operating | Select from Linux or Windows. Other choices can be |
| System | provided in other embodiments. |

The “Add” button is selected to add this source machine to the collector. The collector saves the information and returns to the “Manage Servers” display after saving the values (FIG. 6), where the newly added source machine is displayed in the list. If, instead of selecting “Add”, the “Cancel” button is selected, the collector returns to the Manage Server screen without saving.

The collection of an image may be scheduled on a specific day and time. The collector includes an option for managing scheduled collections. The collection of attributes may be also be scheduled.

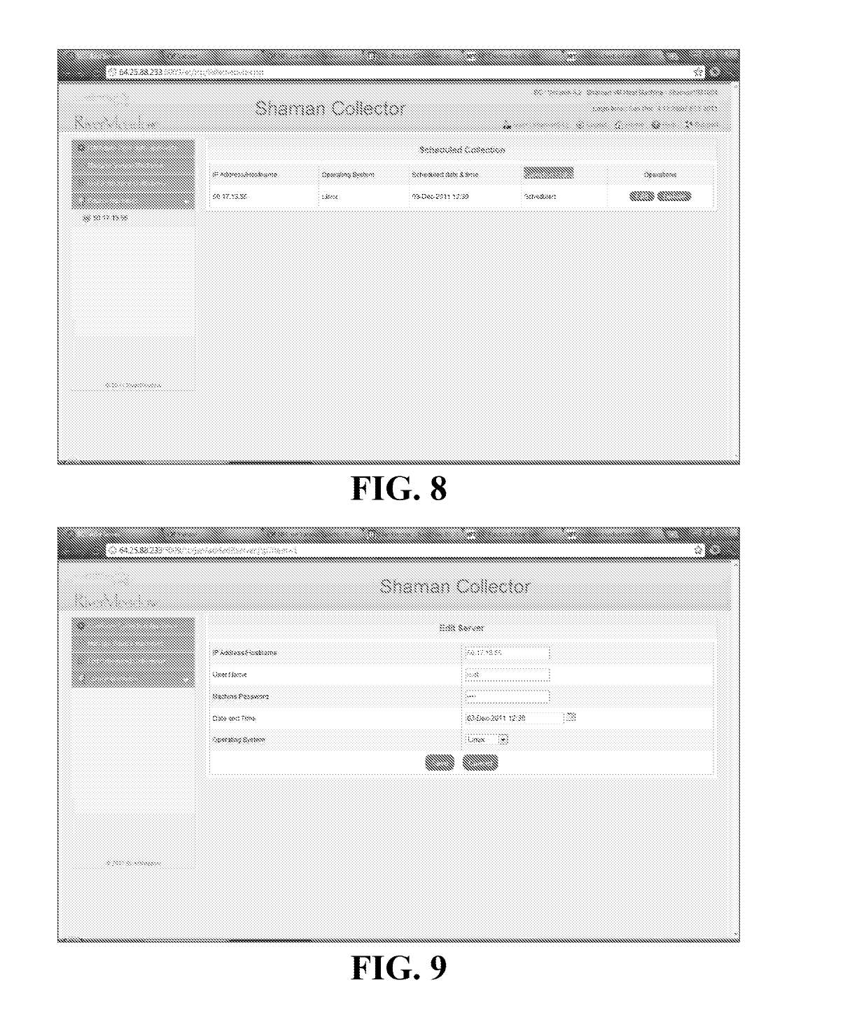

FIG. 8 illustrates a page for managing schedule collections. Five columns are displayed for each source machine: IP Address/Hostname, Operating Systems, Scheduled date & time, Collection Status, and Operations. The allowed Operations for the listed source machine are Edit and Delete. Selection of the “Edit” button opens a display for editing information about a selected source machine.

FIG. 9 illustrates a display for editing source machine information. Table 3 describes inputs for display.

TABLE 3

| Input | Description |
|---|---|
| IP | IP Address of the Appliance. This is required for the source |
| Address/ | servers to be able to connect to the appliance. |
| Hostname | For example, “64.25.88.233”. |
| User Name | User Name of Appliance with root user privileges. |
| | For example, “root”. |
| User | Password for the User Name. |
| Password | |
| Date and | The time of day and the date selected to start the collection |
| Time | for the server. A calendar icon is displayed next to the value |
| | field. Selection of the calendar icon displays a calendar to |
| | select a date. A time selector is provided to select time |
| | using up and down arrows. |
| Operating | Select from Linux or Windows. Other choices can be |
| System | provided in other network embodiments. |

Selecting “Save” effects the changes made to the source machine information, and the collector returns to the “Scheduled Collection” display after saving the changes. Selection of the “Cancel” button cancels the changes and navigates back to the “Manage Server” screen without saving.

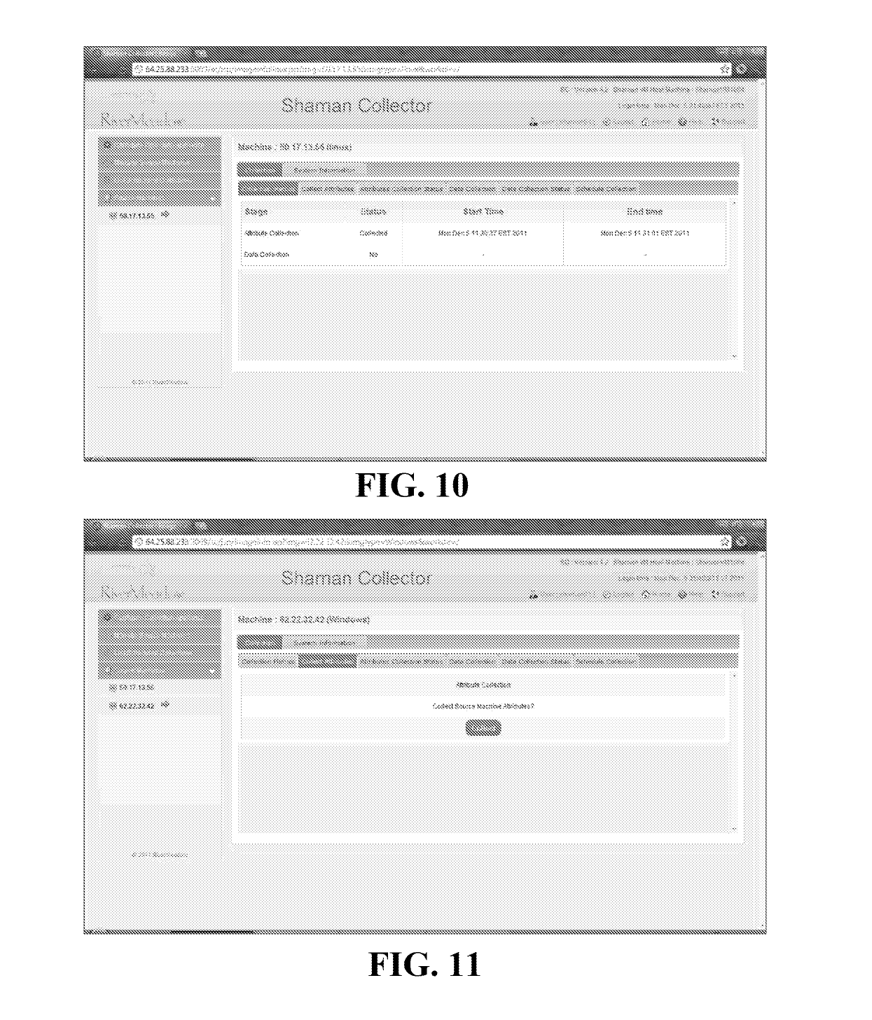

FIG. 10 illustrates information about a source machine. Referring again to FIG. 6, if one of the source machines in the drop down list to the left of the display is selected, the main panel opens a set of tabs for that source machine, as shown in FIG. 10, including a tab labeled “Collect Attributes”.

FIG. 11 illustrates the “Collect Attributes” tab. On this tab, selection of the “Collect” button causes a verification popup box to appear. Selection of the “OK” button in the verification popup box initiates collection. Once initiated, the status bar on the tab indicates progress of the collection. A “Stop Collection” button is also provided. During collection, status messages are displayed on the tab and logged in a file.

Once the attribute collection is completed, the “System Information” tab will include attributes collected.

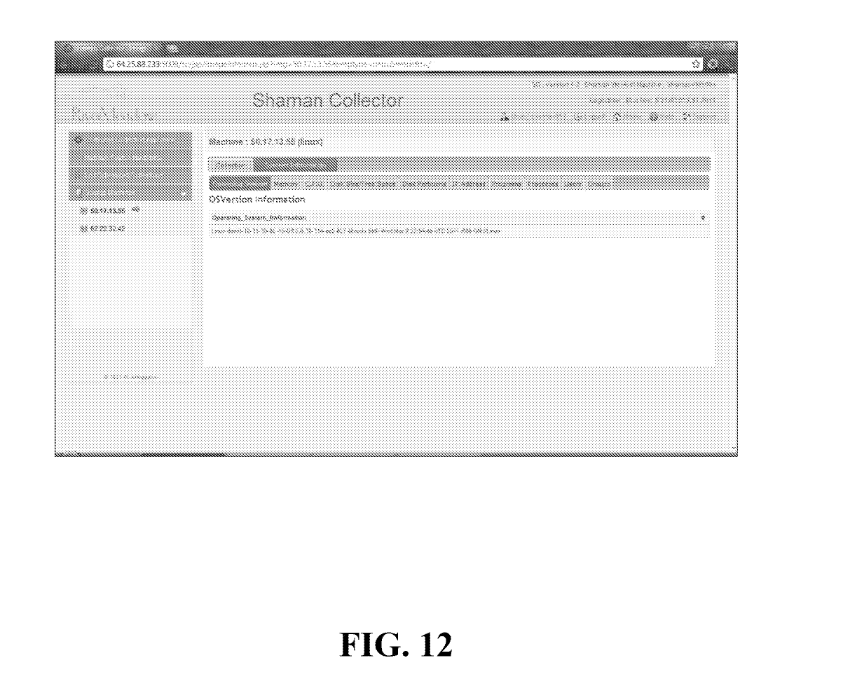

FIG. 12 illustrates the “System Information” tab, which has multiple sub-tabs for different parts of the system. Table 4 describes the contents of the sub-tabs.

TABLE 4

| Input | Description |
|---|---|
| Operating | Operating System information collected, including |
| System | descriptors such as version, type, etc. |
| Memory | Memory information collected, including descriptors |
| | such as Cached, Buffered, Swap, etc. |
| CPU | Processor information collected, including number of |
| | Processors, and descriptors such as Vendor, Model, |
| | Speed, Flags, etc. |
| Disk Size/ | Total size of the disk, and the used and available size |
| Free Space | for all the mount points. |
| Disk Partitions | For Linux this would be in the form of root0disk (/), |
| | /dev/sdb, etc. and for Windows this could be C-drive, |
| | D-Drive, etc. |
| IP Address | IP Address assigned to the source server, including |
| | descriptors such as NetMask, Gateway, Broadcast etc. |
| Programs | List of installed software. |
| Processes | List of the processes running on the source server at the |
| | time of collection. |
| Users | List of users privileged to access this server. |
| Groups | List of assigned groups on this server. |

Referring back to FIG. 11, the “Data Collection” tab provides a data collection option. The Shaman Collector, in similar manner to the collection of attributes, collects data from a source machine.

Once data and attributes are collected from a source machine, the collected information is available on the Shaman appliance. The Shaman Migration Control Center (SMCC) converts the collected information into a hypervisor agnostic image format as an intermediate step and then deploys that image to any hypervisor. The SMCC is a web application that manages the migration of hundreds of servers.

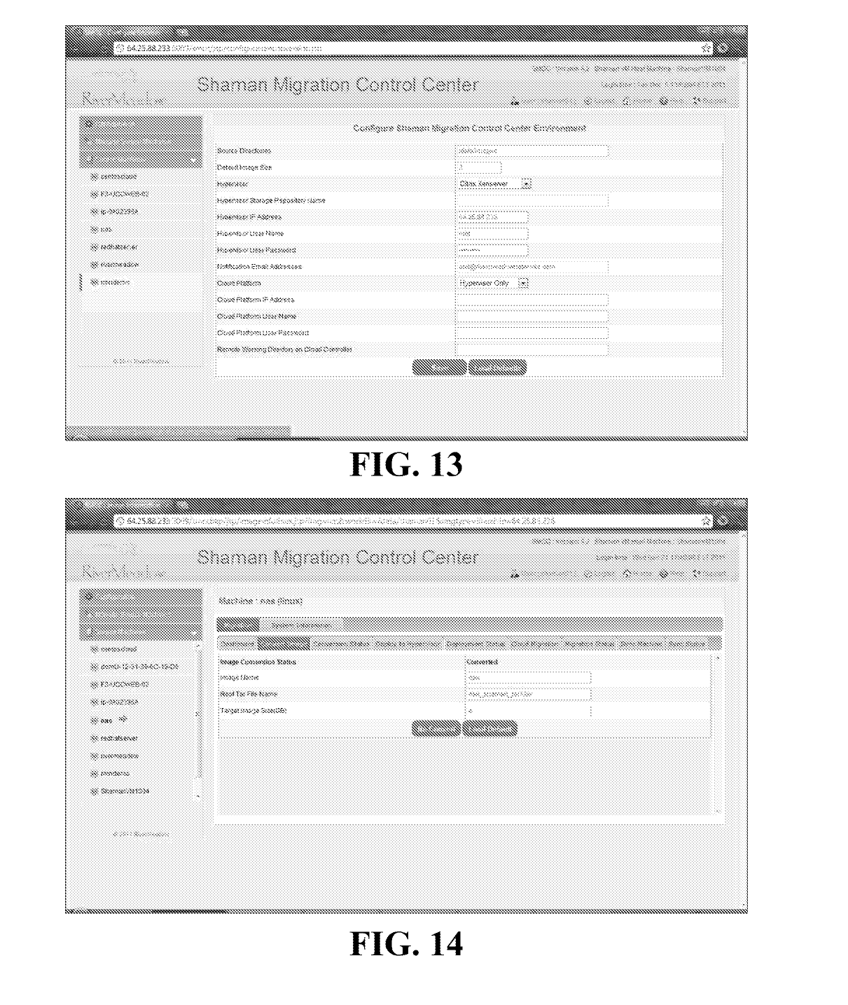

FIG. 13 illustrates a configuration page of the SMCC for a target hypervisor. There may be multiple users per Shaman appliance installed. The multiple users may work in parallel on different images simultaneously. Table 5 describes the contents of selections on the configuration page.

TABLE 5

| Input | Description |
|---|---|
| Source Directories | The directory where the collected images are stored and accessed from |
| | Shaman Appliance. For example, “/data/images”. |
| Default Image Size | The image size needed for the target virtual machine (VM). The size of |
| | the image must at least be equal to the used disk space at the source |
| | machine for an error-free conversion and deployment. |
| Hypervisor | The target hypervisor, for example, VMware ESX/ESXi, Citrix Xen |
| | Server or KVM. |
| Hypervisor Storage | This is a required field only for VMware. If Citrix Xen Server and |
| Repository Name | KVM is selected as the hypervisor, this field will be not be editable. |
| Hypervisor IP | IP Address of the hypervisor chosen. For example, “64.25.88.233”. |
| Address | |
| Hypervisor User | User Name of the selected hypervisor with root user privileges. For |
| Name | example, “root”. |
| Hypervisor User | Password for the User Name at the selected hypervisor. |
| Password | |
| Notification Email | An option to send notifications during a migration process. A comma |
| Addresses | separated list of emails may be entered here. |
| Cloud Platform | The destination. For example, “Hypervisor only”, “Openstack”, |
| | “Amazon EC2”, and “VMware vCloud”. If the choice is “Hypervisor |
| | only”, the target VM will be deployed on the selected hypervisor. |
| Cloud Platform IP | IP Address of the chosen Cloud Platform, not required if the choice is |
| Address | “Hypervisor only”. |
| Cloud Platform User | User Name of the selected Cloud Platform with root user privileges. For |
| Name | example, “root”. |
| Cloud Platform User | Password for the User Name at the selected Cloud Platform. |
| Password | |
| Remote Working | Directory name. |
| Directory on Cloud | |
| Controller | |

If there are any collected images available for conversion, they are displayed in the left pane as shown in FIG. 13. Selection of the “Manage Source Machines” option at the left allows deletion of a source machine. A deletion verification box is displayed if a “Delete” option is selected for a source machine. Selection of “OK” in the deletion verification box causes the image of the selected source machine to be deleted from storage and from the list.

There is also a broom icon on the top right side of the screen, as shown in FIG. 13, for cleaning up the conversion environment. After every successful conversion and deployment, lingering files are not necessary to keep and may be deleted by selecting the broom icon.

Selection of one of the source machines listed in the left pane will open a set of tabs for that machine.

FIG. 14 illustrates a set of tabs for the machine named “nas”, with the “Convert Image” tab selected. Table 6 describes the contents of selections on the “Convert Image” tab. The options shown are for a Linux operating system and may be different for another operating system.

TABLE 6

| Input | Description |
|---|---|
| Image Name | The name of the image from the source server. This can |
| | not be edited. |
| Root Tar File | Root file system from the source server that was |
| Name | collected. This can not be edited. |
| Target Image | By default, the value is filled from the configuration. If |
| Size (GB) | this server has a different disk space used, this value |
| | may be changed. |

A conversion verification box is displayed if a “Convert” option is selected for a source machine. Selection of “OK” in the conversion verification box causes the image of the selected source machine to be converted. A status bar shows progress of the conversion, and the “Conversion Status” tab shows progress of the conversion in percentage. The conversion may be halted by selecting a “Stop Conversion” button. Status messages may be displayed on the “View Conversion Logs” tab and stored in a message log. Metrics related to a completed conversion are available on the “Dashboard” tab.

Following a successful conversion, the image may be deployed.

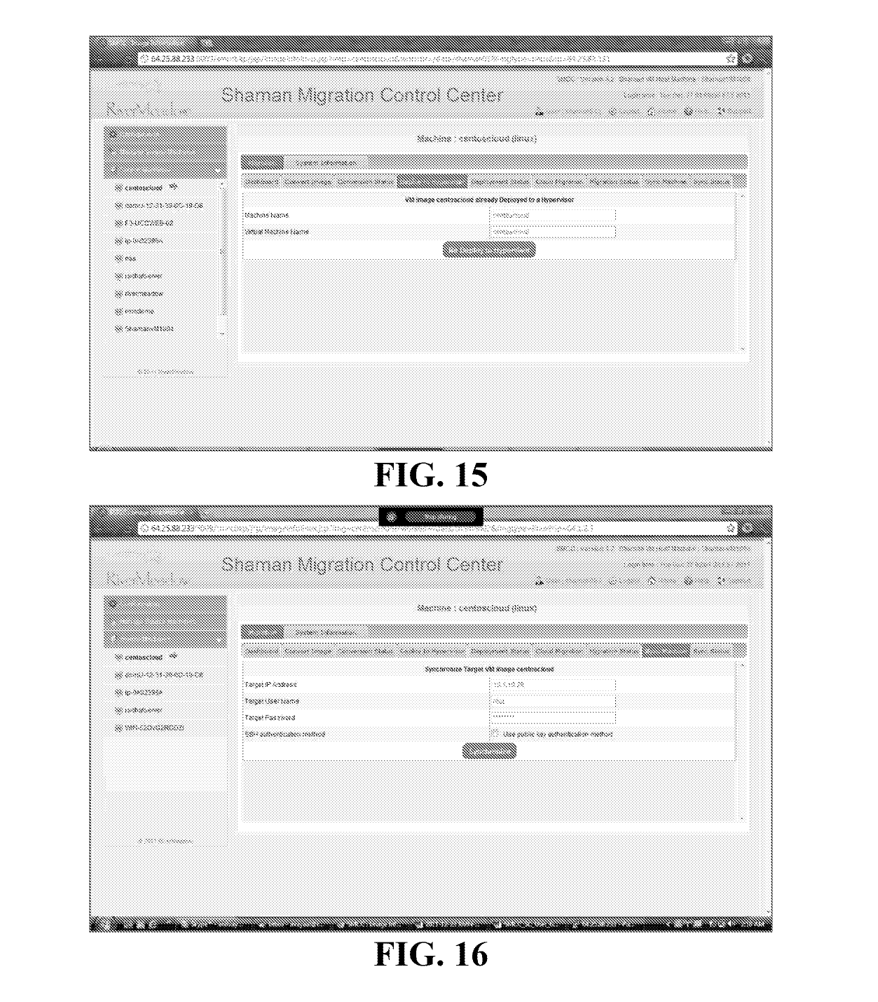

FIG. 15 illustrates a “Deploy to Hypervisor” tab related to a source machine named “centoscloud”. The tab displays the name of the image from the source machine, which is not editable, and a virtual machine name that defaults to the source machine name but may be changed. A deployment verification box is displayed if a “Deploy” option is selected for a source machine. Selection of “OK” in the deployment verification box causes the image of the selected source machine to be converted for a target hypervisor. A status bar shows progress of the deployment, and the “Deployment Status” tab shows progress of the deployment in percentage. The deployment may be halted by selecting a “Stop Deployment” button. Status messages may be displayed on the “View Deployment Logs” tab and stored in a message log. Metrics related to a completed deployment are available on the “Dashboard” tab.

Following a successful deployment, data is synchronized.

FIG. 16 illustrates a “Sync Machine” tab related to a source machine named “centoscloud”. Table 7 describes the contents of selections on the “Sync Machine” tab.

TABLE 7

| Input | Description |
|---|---|
| Target IP | The IP Address or hostname of the running |
| Address | target VM instance. |
| Target User | The super user name of the running target |
| Name | VM instance. |
| Target | The password for the Target User Name. |
| Password | |
| SSH | For Linux systems: the box is to be checked if SSH key |
| authentication | authentication is used and the authentication file is the |
| method | same as that used for the source during collection. |

A synchronize verification box is displayed if a “Synchronize” option is selected for a source machine. Selection of “OK” in the synchronize verification box causes the data of the selected source machine and the data on the target hypervisor to be synchronized. A status bar shows progress of the synchronization. Status messages may be displayed on the “Sync Status” tab. Metrics related to a completed synchronization are available on the “Dashboard” tab.

The Shaman Collector and Shaman Migration Control Center as illustrated and described are examples of tools that may be used in a migration platform, such as tools included with a migration appliance 440 on a migration platform 430 such as those illustrated in FIG. 4. The invention is not limited to the features of the Shaman tools described.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, or a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, Objective C, PROLOG, or in any byte code language such as JAVA. The software programs may be stored on or in one or more articles of manufacture as object code.

While certain exemplary embodiments have been described and shown in the accompanying drawings, it is to be understood that such embodiments are merely illustrative of and not restrictive on the methods and systems described herein. Additionally, it is possible to implement the methods and systems described herein or some of its features in hardware, programmable devices, firmware, software or a combination thereof. The methods and systems described herein or parts of the methods and systems described herein may also be embodied in a processor-readable storage medium or machine-readable medium such as a magnetic (e.g., hard drive, floppy drive), optical (e.g., compact disk, digital versatile disk, etc), or semiconductor storage medium (volatile and non-volatile).

Having described certain embodiments of methods and systems for migrating a machine from a source platform to a destination platform, it will now become apparent to one of skill in the art that other embodiments incorporating the concepts of the disclosure may be used.

1. A method for migration of a source machine from a source platform to a destination platform, comprising:
collecting an image of the source machine in a storage device of a migration platform;
converting the image of the source machine in a migration appliance of the migration platform, the image converted for deployment in a virtualization environment;
deploying the converted image of the source machine to a selected virtualization environment in the destination platform for deployment; and
providing synchronizing data to synchronize the deployed image with current data on the source machine, if the data on the source machine has changed since the image of the source machine was collected.

2. The method of claim 1, wherein the source machine is a virtual machine.

3. The method of claim 1, wherein the source machine is a server.

4. The method of claim 1, wherein the source machine is a server farm.

5. The method of claim 1, further comprising collecting attributes of the source machine.

6. The method of claim 5, wherein the attributes and image are collected substantially simultaneously.

7. The method of claim 5, further comprising scheduling a collection of at least one of attributes and image for a future time, such that at the future time the collection is initiated automatically.

8. The method of claim 1, wherein conversion of the image for deployment in a virtualization environment is conversion of the image to a hypervisor-agnostic image, and the selected virtualization environment is a specific hypervisor.

9. The method of claim 8, wherein the hypervisor is part of a cloud platform.

10. The method of claim 9, wherein deploying to the cloud platform includes creating a template for creating virtual machines.

11. The method of claim 1, further comprising testing the converted image in the migration appliance prior to deployment in the destination platform.

12. The method of claim 1, wherein the converted image is resized prior to deployment in the destination platform.

13. The method of claim 1, wherein the converted image of the source machine is deployed in multiple instances on the destination platform.

14. The method of claim 1, further comprising configuring the operating system and application parameters to accommodate differences between the source and target environments.

15. The method of claim 1, further comprising modifying the collected image to account for differences in drivers between the source platform and the destination platform.

16. The method of claim 1, further comprising modifying the collected image by one of adding or deleting a software package.

17. The method of claim 1, performed as Software as a Service (SaaS).

18. A migration platform for migration of a source machine from a source platform to a destination platform, comprising:
at least one computing device, the at least one computing device including a migration appliance;
a storage device; and
at least one network interface,
wherein the migration platform is configured to
initiate an image collection;
collect in the storage device an image of the source machine;
convert in the migration appliance the image of the source machine for deployment in a virtualization environment;
deploy from the migration appliance to a selected virtualization environment in the destination platform the converted image of the source machine; and
provide synchronized data to the destination platform, if the data on the source machine has changed since the image of the source machine was collected.

19. The migration platform of claim 18, wherein the source machine is a virtual machine.

20. The migration platform of claim 18, wherein the source machine is a server.

21. The migration platform of claim 18, wherein the source machine is a server farm.

22. The migration platform of claim 18, wherein conversion of the image for deployment in a virtualization environment is conversion of the image to a hypervisor-agnostic image, and the selected virtualization environment is a specific hypervisor.

23. The migration platform of claim 22, wherein the hypervisor is part of a cloud platform.

24. The migration platform of claim 18, further comprising collecting attributes of the source machine.

25. The migration platform of claim 24, further comprising scheduling a collection of at least one of attributes and image for a future time, such that at the future time the collection is initiated automatically.

26. The migration platform of claim 18, further comprising modifying the collected image by one of adding or deleting a software package.

27. The migration platform of claim 18, wherein the migration requires no software to be installed on the source machine.

28. A conversion toolset, comprising:
a collection tool configured to collect an image of a source machine;
a conversion tool configured to convert the image of the source machine for deployment on a destination platform;
a configuration tool configured to update operating system and application parameters for the target environment;
a testing tool configured to test the converted image prior to deployment;
a deployment tool configured to provide the converted image to the destination platform for deployment; and
a synchronization tool configured to synchronize data of the converted image after deployment, such that data on the source machine modified since the collection of the image of the source machine is provided to the destination platform to replace stale data.
